(19) United States
(12) Patent Application Publication
(10) Pub. No.: US 2014/0266690 A1
(43) Pub. Date: Sep. 18, 2014

(54) AUTOMATED EVENT SEVERITY DETERMINATION IN AN EMERGENCY ASSISTANCE SYSTEM

(71) Applicant: SaferAging, Inc., Reston, VA (US)

(72) Inventors: John McKINLEY, Great Falls, VA (US); Christopher WILLIAMS, Herndon, VA (US)

(73) Assignee: SaferAging, Inc., Reston, VA (US)

(21) Appl. No.: 13/839,279

(22) Filed: Mar. 15, 2013

(51) Int. Cl. G08B 25/00

(52) U.S. Cl. CPC G08B 25/00
USPC 340/539.11; 340/540

(57) ABSTRACT

A system and method for generating alerts for events in an emergency assistance system are provided. A report of an event is received from an event detecting device along with related information. A severity of the event is determined based at least in part on the related information, and one or more alerts are generated for responding to the event based at least in part on the severity. The related information can include audio recorded based on occurrence of the event, other component measurements based on occurrence of the event, etc.

### CROSS-REFERENCE TO RELATED APPLICATIONS

This application relates to co-pending U.S. patent application Ser. No. ______, entitled “MULTIPLE-RADIO PENDANTS IN EMERGENCY ASSISTANCE SYSTEMS,” filed Mar. 15, 2013, co-pending U.S. patent application Ser. No. ______, entitled “DYNAMIC PROVISIONING OF PENDANT LOGIC IN EMERGENCY ASSISTANCE SYSTEMS,” filed Mar. 15, 2013, co-pending U.S. patent application Ser. No. ______, entitled “EVENT DETECTION AND REPORTING USING A GENERAL PURPOSE PROCESSOR AND A HARDENED PROCESSOR,” filed Mar. 15, 2013, and co-pending U.S. patent application Ser. No. ______, entitled “HIGH RELIABILITY ALERT DELIVERY USING WEB-BASED INTERFACES,” filed Mar. 15, 2013, all of which are assigned to the assignee hereof, and the entireties of which are herein incorporated by reference for all purposes.

### BACKGROUND

Alert detection systems typically include a plurality of event detection devices located in a building, and a mechanism for communicating detected events to a centralized station for processing of the events and subsequent remediation. The event detection devices can communicate to an event detecting system within the building, which can access the centralized station via a remote connection therewith. Upon detecting an event, the event detection device can alert the on-site event detecting system, which can transmit relevant alert information to the centralized station. The information is interpreted at the centralized station, and assistance is provided where deemed necessary based on the information. In emergency assistance systems with wearable pendants, detection of an emergency button push event on the pendant causes the pendant to transmit an alert to the event detecting system, which forwards the alert along with other relevant information (e.g., location of the event detecting system) to the centralized station. Someone at the centralized station receives the alert, and can perform one or more actions in response to the alert, such as dispatch emergency services to the location where the event detecting system is installed, communicate with a person via a microphone and speaker installed within the building (e.g., and connected to the event detecting system), and/or notify on-site care personnel of the alert (e.g., where the building is an assisted-living or other care management facility).

As computer technology and capability advances, additional mechanisms for communicating detected alerts and related information have been developed. In one case, Internet-based alerting is possible where the on-site event detecting system communicates with the centralized station over an Internet connection to deliver events thereto. Similarly, subsequent alerting from the centralized station to on-site care personnel can be via Internet connection therebetween.

### SUMMARY

The following presents a simplified summary of one or more aspects to provide a basic understanding thereof. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that follows.

Aspects described herein relate to automatically determining severity of an event detected in an emergency assistance system. For example, information regarding the event from an event detecting device in the emergency assistance system is evaluated to infer or otherwise determine a severity of the event. Based on the determined severity, for example, alerting for subsequent remedial action can be determined, such as whether to contact a person regarding the event (e.g., a person at a location of the event detecting device, a person wearing the event detecting device, etc.), whether to dispatch emergency assistance services to a location of the event detecting device, and/or the like. Information that can be used in determining the severity can include audio recorded following detection of the event, parameters measured by the device in detecting the event or measured before or after the detection, such as location, time of day, historical activity data, recent activity, cameral input, medical profile, etc.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations may denote like elements, and in which:

FIG. 1 is an aspect of an example emergency assistance system for processing events and rendering related alerts.

FIG. 2 is an aspect of an example system for determining severity of one or more reported events.

FIG. 3 is an aspect of an example pendant for detecting and reporting events and related information.

FIG. 4 is an aspect of an example methodology for determining a severity of one or more reported events.

FIG. 5 is an aspect of an example methodology for generating alerts for reported events based on a level of severity.

FIG. 6 is an aspect of an example system in accordance with aspects described herein.

FIG. 7 is an aspect of an example communication environment in accordance with aspects described herein.

### DETAILED DESCRIPTION

Reference will now be made in detail to various aspects, one or more examples of which are illustrated in the accompanying drawings. Each example is provided by way of explanation, and not limitation of the aspects. In fact, it will be apparent to those skilled in the art that modifications and variations can be made in the described aspects without departing from the scope or spirit thereof. For instance, features illustrated or described as part of one example may be used on another example to yield a still further example. Thus, it is intended that the described aspects cover such modifications and variations as come within the scope of the appended claims and their equivalents.

Described herein are various aspects relating to determining a severity of an event detected in an emergency assistance system. An event detecting device, such as a pendant, a wall-mounted device, a passive sensor that detects activity, motion, temperature, etc., can detect the event and can indicate information regarding the detected event. The information can include measurable data regarding the event, such as measurements by components of an event detecting device from which the event was detected (e.g., location, time of day, activity measurements, etc.), component measurements following the event, audio or video recorded before, during, and/or following the event (e.g., via a microphone or camera in the event detecting device or on a nearby wall mount, etc.), medical profile, and/or the like. The information can be analyzed automatically to determine a severity of the event. The severity of the event can be used to determine an appropriate alert based on a level of remediation for the event, such as whether to contact a person wearing the device for more information, whether to contact an aide or professional at a location where the device operates, whether to dispatch emergency services to a location of the device, and/or the like. For example, recorded audio following the detected event can be captured and at least one of transcribed to detect existence of certain words, analyzed to detect certain sound patterns, analyzed to detect audio attributes, such as pitch, volume, etc., and/or the like. Based on detecting the certain words, a matched pattern, a threshold pitch, volume, etc., and/or the like, the level of severity and/or corresponding alerting/remedial measures can be determined.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Artificial intelligence based systems (e.g., explicitly and/or implicitly trained classifiers) can be employed in connection with performing inference and/or probabilistic determinations and/or statistical-based determinations in accordance with one or more aspects of the subject matter as described hereinafter. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for generating higher-level events from a set of events and/or data. Such inference results in the construction of new events or actions from a set of observed events or stored event data, regardless of whether the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines, etc.), for example, can be employed in connection with performing automatic and/or inferred actions in connection with the subject matter.

Furthermore, the subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it is to be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the subject matter.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

FIG. 1 illustrates an example system 100 for processing events in an emergency assistance system. System 100 includes an event processing component 102 for receiving, processing, and/or reporting events received from one or more event detection devices (not shown). Event processing component 102 includes an event data aggregating component 104 for obtaining event data from one or more event detection devices, and a severity determining component 106 for determining a severity of the event based on one or more parameters received regarding the event. System 100 also includes an alerting component 108 for rendering one or more alerts over a network 110 based at least in part on the event data and/or determined severity. System 100 also includes an event detecting device 112 that can report events and/or related information to event processing component 102 via network 110, and/or an optional monitoring component 114 to which alerting component 108 can attempt to render one or more alerts.

System 100 may also include an event detecting system 116 that can communicate with multiple event detecting devices installed at a site, such as event detecting device 112, and may function as a gateway facilitating communicating between the event detecting devices and network 110. Thus, event detecting system 116 can communicate with event processing component 102 via network 110, and is accordingly coupled to network 110. This can include a wireless coupling, such as a WiFi connection to network 110 via a router or other network component, a cellular connection to network 110, etc., a wired coupling, such as over a local area network (LAN), and/or the like. Moreover, network 104 can include a collection of nodes communicatively coupled with one another via one or more components (e.g., switches, routers, bridges, gateways, etc.), which can include, or can include access to, an Internet, intranet, etc. In addition, in an example, event processing component 106 and alerting component 108 can each be, or can collectively include, one or more servers purposed with performing at least a portion of the described functionalities. Thus, in one example, one or more of the components 106 or 108 can be distributed among multiple servers within network 104 in a cloud computing environment.

According to an example, event detecting device 112 can detect and report one or more events to event processing component 102 over network 110 (e.g., which may include event detecting system 116 acting as a gateway to facilitate the reporting). Moreover, event detecting device 112 can include information for detecting severity of the event in the reported information. For example, event detecting system 116 can include audio recorded for a given period of time following detecting the event, event details such as measurements from one or more components of event detecting device 112 that resulted in detection of the event, measurements from components of event detecting device 112 before or after detection of the event, and/or the like. Event data aggregating component 104 can obtain the event information, and severity determining component 106 can determine a severity of the event based at least in part on the event information and/or any other information received therewith.

Severity determining component 106 can indicate the event and/or the determined severity to alerting component 108. Alerting component 108 can determine one or more alerts to send regarding the event based on the severity. For example, severity determining component 106 can indicate the severity as a certain type of enumerated event (e.g., emergency, possible emergency, notification, etc.), a numeric grade (e.g., 1-10), a determined alerting or remedial measure (e.g., dispatch emergency services, contact user of event detecting device 112, alert monitoring component 114, etc.), and/or the like. Thus, alerting component 108 determines one or more alerts to render based on this information. In one example, monitoring component 114 can be on-site with the event detecting device 112, and thus, alerting component 108 can transmit an alert to monitoring component 114 indicating the event related to event detecting device 112, which can include a location of the event detecting device 112.

FIG. 2 illustrates an example system 200 for generating event alerts based on an indicated severity. System 200 includes a severity determining component 106 for determining a severity related to one or more reported events, an alerting component 108 for transmitting one or more alerts regarding the events based on the determined severity, and an event detecting device 112 for detecting and reporting the events. As described, severity determining component 106, alerting component 108, and/or event detecting device 112 can each be remotely located from one another, and can communicate with each other over one or more networks. Severity determining component 106 can include an audio receiving component 202 for obtaining audio recorded based at least in part on an event, an audio processing component 204 for measuring one or more parameters of the audio to determine a severity of the event, and an event parameter measuring component 206 for measuring other parameters regarding the event to determine the severity thereof. System 200 also optionally includes a recording device 216 for recording audio related to the event to determine a severity thereof.

According to an example, event detecting device 112 can detect an event, which can be based on measuring one or more component parameters of the event detecting device 112 (e.g., a fall detected based at least in part on accelerometer measurements, detected location change, etc.), detecting activation of a component of the event detecting device 112 (e.g., an emergency button push), receiving a request for event-type information from a centralized station of an emergency assistance system, and/or the like. Event detecting device 112 may additionally collect other information related to the detected event, such as audio recorded based on occurrence of the event, parameter measurements of certain components before or after the detected event, and/or the like. For example, event detecting device 112 can record audio via a microphone for a period of time following a detected event and/or until another event is detected by event detecting device 112. For example, event detecting device 112 can detect a certain word spoken into the microphone to cease recording, a button push on event detecting device 112 to cease recording, and/or the like. Event detecting device 112 can send and/or stream the audio to severity determining component 106 (e.g., via an event processing component or otherwise).

In another example, recording device 216 can record audio based on event detecting device 112 detecting the event. In one example, recording device 216 can receive instructions from the event detecting device 112 and/or an on-site event detecting system to record based on a detected event. In another example, recording device 216 can persistently record, and recorded data from a specified period in time can be obtained from the recording device 216 based on detecting an event. Recording device 216 can be a microphone, camera with microphone input, etc., which can be wall-mounted at a site where the event detecting device 112 operates. The recording device 216 can be connected to an event detecting system, event detecting device 112, or otherwise over a network (e.g., via a wired or wireless connection) to provide recorded data to severity determining component 106. Thus, in one example, the recording device 216 can include a webcam or similar device that can record and transmit audio and/or video data over a network.

Audio receiving component 202 can obtain the audio recorded by event detecting device 112, recording device 216, etc. Audio processing component 204 can determine one or more parameters related to the audio. In one example, transcription evaluating component 210 can generate and/or analyze a transcription of the audio received from event detecting device 112 to determine occurrence of one or more words that may indicate a level of severity for the event. Transcription evaluating component 210, for example, can generate the transcription using an automated transcriber on the audio, by receiving a manual transcription from a service, and/or the like. In another example, pattern recognizing component 212 can attempt to recognize patterns in the signal of the audio received from event detecting device 112. In yet another example, attribute measuring component 214 can detect certain attributes of the audio received from event detecting device 112.

In specific examples, transcription evaluating component 210 can attempt to detect occurrence of words such as “help,” fallen,” “emergency,” etc. in the transcription, which may result in determining a higher severity for the event as opposed to where such words are not present. In another example, transcription evaluating component 210 can attempt to detect sounds that cannot be transcribed or transcribe into screaming, moaning, etc., as such can indicate a high severity as compared to regular speech (which may indicate an accidental button push or other low severity event). In other specific examples, pattern recognizing component 212 can match patterns that relate to certain sounds that may indicate an event, such as a loud quick thud, which may indicate a fall of the user or something near the user which may have injured the user. Thus, such detected sounds can result in assigning a higher severity to the event. In another example, pattern recognizing component 212 can match speech patterns of the user that may indicate event severity. The pattern recognizing component 212, in one example, can be trained using audio samples from a given user. In one example, such samples can be received via event detecting device 112 (e.g., over a network) upon initialization of the event detecting device 112. In additional specific examples, attribute measuring component 214 can measure a volume or intensity of audio received from the event detecting device 112 throughout the sample (e.g., an average volume), which can be indicative of a stress level of the user of the event detecting device. Moreover, in an example, attribute measuring component 214 can determine a number of volume increases and/or periods of low sound during the sample, which can be indicative of noises other than normal speech, and/or the like, for assigning a higher severity to the event.

In additional examples, event parameter measuring component 206 can analyze additional parameters or information received from event detecting device 112 related to the event. In one example, event parameter measuring component 206 can receive audio transcription from event detecting device 112. In this regard, the transcription engine at the event detecting device can be trained by the user thereof to provide more accurate transcription. Additional parameters received by event parameter measuring component 206 can relate to measurements of components of event detecting device 112 that caused detecting of the event (e.g., accelerometer measurements of the event detecting device 112 where the event is a fall detection), additional measurements at the time of the event (e.g., time of day, location, ambient temperature, activity or inactivity, etc.), measurements for a time period before or after the event (e.g., location, ambient temperature, acceleration, activity and/or inactivity, etc.), profile related parameters, such as a medical profile of a person to which the event detecting device 112 is associated, and/or the like. In other examples, event parameter measuring component 206 can also receive additional information from other event detection devices as well, such as a passive sensor installed near the location of the reported event (e.g., a detected motion measurement, ambient temperature measurement, etc., as described herein), etc. This information can assist in inferring a severity of the event.

Event parameter measuring component 206 can compare the one or more parameters to one or more thresholds related to determining the severity of the event. For instance, a rate of acceleration used to detect a fall can be used to determine a severity thereof (e.g., by comparing to accelerations related to one or more levels of severity), combined motion detection from a passive sensor can verify the acceleration or other aspects of the fall, another acceleration before or following the fall can indicate further or frequent falling, an ambient temperature (and/or location) change before the fall can indicate a fall outdoors, which may be more severe, a location measurement before the fall can indicate a part of a site where the fall occurred, which may be more severe (e.g., a fall in the bathroom may be more severe than a fall in the living room), etc.

In any case, alerting component 108 can generate one or more alerts based on the determined severity. Severity determining component 106 can indicate the severity to alerting component 108 for determining the type of event(s) to render, and alerting component 108 selects the one or more alerts based on comparing the severity to one or more thresholds. For example, for high severity events, alerting component 108 can dispatch emergency services to an address of the user (e.g., or an address reported by event detecting device 112). For events having at least another threshold severity, alerting component 108 can alert an on-site or remotely located user to reach out to the user of event detecting device 112 to see if they need assistance (e.g., via phone call, via activating a camera on-site to view and/or correspond with the person, etc.). This can occur, in one example, via event detecting device 112 where equipped to receive live audio over a network or from an on-site event detecting system. Moreover, for events having at least another threshold severity, alerting component 108 can generate the alert, in an example to a monitoring station at an assisted living facility or other facility that houses users of event detecting devices 112. In other examples, alerting component 108 can generate alerts to a family member of the user or other parties (e.g., a doctor for the user, etc.) for varying levels of severity. In one example, the level of severity that generates an alert can be configured by the party receiving the alert (e.g., a doctor may want to receive higher severity alerts than a family member).

FIG. 3 illustrates an example pendant 300 for operation in an emergency assistance system. For example, pendant 300 can be a wearable pendants, which can include various form factors, such as a pendant with a lanyard for wearing around the neck, a watch form factor for wearing on a wrist (e.g., where the watch can function as a watch and also include the pendant or components thereof), etc. In other examples, pendant 300 can be another device installed at a site for a user using the emergency assistance system, such as a wall-mounted event detecting device, a passive sensor, and/or the like. Pendant 300 can include one or more of the various components depicted to facilitate event detection and reporting by the pendant 300. For example, pendant 300 can include an emergency button 302 for indicating an emergency by activating the button, a processor 304, which can include a general purpose processor, for executing event detection and reporting logic, and a memory 306 to store instructions for executing the logic, data, or other information related to event detecting and reporting. Pendant 300 can also include a main radio 308 and a secondary radio 310, which can utilize different wireless communication technologies, to facilitate contingent reporting events or other information to one or more components of an emergency assistance system.

Pendant 300 can also include a speaker 312 to render audio tones or messages, which can be a local piezo buzzer or similar mechanism, a microphone 314 to record audio, and a light emitting diode (LED) array 316, or similar illumination source, for displaying light for a detected event. Pendant 300 may also include a battery 318 to power the pendant, an accelerometer 320 to measure acceleration of the pendant 300, a digital barometer 322 to measure height change of the pendant 300, a thermometer 324 to measure ambient temperature, and a GPS receiver 326 to determine a GPS position of the pendant 300. Pendant 300 also optionally includes an audio transcribing component 328 to transcribe audio received via microphone 314, which can be reported to the emergency assistance system based on occurrence of an event, as described. Pendant 300 can also optionally include an audio receiving component 202, an audio processing component 204, and/or an event parameter measuring component 206, which can operate as described above, but as part of the pendant to determine a severity for reporting a detected event.

According to an example, pendant 300 can operate according to one or more defined thresholds for measured parameters of the various components to facilitate detecting events, such as fall detection, inactivity monitoring, environmental monitoring, etc. In addition, pendant 300 can provide for local alarming, reminder playback, audio recording, and/or the like. In one specific example, the pendant 300 can specify parameter thresholds for fall detection, which can include detecting an acceleration measurement above a threshold via accelerometer 320 combined with a height adjustment measurement over a threshold via digital barometer 322. Where such is detected, main radio 308 and/or secondary radio 310 can attempt to communicate a fall detection event to the emergency assistance system.

In another specific example, the pendant 300 can specify parameters for activity/inactivity monitoring, which can include inferring activity based on accelerometer 320 measurements, measurements of position over time from GPS receiver 326, etc. Pendant 300 can define parameter thresholds for detecting events related to too much inactivity (which may indicate the person is in distress). The thresholds may vary for different profiles, during different times of day, etc. For example, a minimum threshold for acceleration measurements via accelerometer 320 may be lower midday than overnight, as the person may be assumed to be sleeping overnight. In addition, in an example, the pendant 300 can define parameter thresholds for allowed location of the pendant measured by GPS receiver 326 (e.g., to facilitate range fencing of a person where an event is triggered when the pendant is determined to be outside of an allowed location range). In yet another example, the pendant 300 can specify parameter thresholds for detecting events based on temperature according to measurements by thermometer 324, which can also be specific for a given pendant. Thus, a lower range of temperature can be acceptable as specified for a person who prefers to keep their house (or other site of emergency assistance system installation) cooler.

In any case, pendant 300 can include additional information in reporting the event to facilitate determining a severity thereof, as described. For example, microphone 314 can record audio for a period of time based on the event. The period of time can be defined in logic operated by the pendant 300 and/or can relate to detecting a subsequent event, such as recognized audio, detection of another event for reporting, and/or the like. Pendant 300 can send or otherwise stream the audio to an emergency assistance system, as described herein, and/or to an on-site event detecting system for provisioning to the emergency assistance system (e.g., via main radio 308, secondary radio 310, etc.). In another example, audio transcribing component 328 can transcribe the audio recorded by microphone 314, and pendant 300 can send the transcription to the emergency assistance system. In one example, microphone 314 can be a microphone of a camera in the pendant 300.

In another example, audio receiving component 202 can obtain audio from the microphone 314 and/or from on-site recording devices, such as a wall-mounted microphone or camera on the site of the pendant 300 (e.g., connected to an event detecting system or otherwise coupled to pendant to deliver the audio). Audio processing component 204 can analyze the audio to determine an event severity as described (e.g., based on transcribing the audio, analyzing properties or patterns thereof, etc.). In other examples, event parameter measuring component 206 can measure parameters of the other components of pendant 300, as described herein to determine event severity. Processor 304 can utilize the severity for reporting the detected event.

Moreover, in an example, additional information communicated by the pendant 300 can include measurements of the one or more components during, before, and/or after the reported event. In one example, pendant 300 can include accelerometer 320 measurements in reporting fall detection or other event (e.g., measurements that caused the fall detection, measurements for a time period before the detected fall and/or after the detected fall, etc.) to a severity determining component or other component of an emergency assistance system. Moreover, as described, pendant 300 can report thermometer 324 measurements before, during, or after the event, GPS receiver 326 location measurements, location measurements triangulated by measuring received signal strengths from main radio 308, secondary radio 310, etc., and/or the like. Severity of the event can be determined based on the additional measurements as well. In a specific examples, the detected event can correlate to location change after a certain time of day detected by GPS receiver 326 (e.g., leaving house in the middle of the night), and pendant 300 can include location measurements from the GPS receiver 326 in reporting the event for severity determination.

Moreover, the pendant 300 can define parameters for certain audio playback via speaker 312, such as a reminder to take medicine played at certain times of day. It is to be appreciated that the audio files can be included in the logic or otherwise obtained and stored in memory 306. In another example, the audio can be streamed (e.g., over the main radio 308) as specified in the logic. The delivery mechanism, content, and instructions for playing the audio can all be defined in logic, which may be provisioned to pendant 300. In further examples, the logic can specify parameters related to event reporting, such as: an audio stream, volume, duration, etc. for sounding an alarm on speaker 312 for certain detected events; duration, intensity, pattern, color, etc. for flashing LEDs in LED array 316 for certain detected events; audio sampling duration for microphone 314 based on certain detected events; and/or the like. For instance, the audio sampling data from microphone 314 can be transmitted to the emergency assistance system for playback to personnel, automated severity determination, etc.

In additional examples, the pendant 300 can operate one or more power management schemes to conserve power of the battery 318 (e.g., in certain detected contexts, such as main radio 308 failure or loss of connection, secondary radio 310 failure or loss of connection, etc.). In one example, where battery 318 is low, power management component 328 can disable accelerometer 320, digital barometer 322, thermometer 324, GPS receiver 326, etc. and/or can activate a periodic audio indicator via speaker 312 to notify of the low power state. The power management can be according to one or more defined power management schemes, which may be provided to the pendant 300. In one example, the power management scheme can continue to shutdown components while maintaining power to the emergency button 302 for as long as possible.

Moreover, in an example, the pendant 300 can define parameter thresholds for detecting a lost pendant event; for example, this can include detecting that the pendant 300 has not moved location over a certain period of time via GPS receiver 326 measurements, detecting the pendant 300 has been in a low power state during this time, determining that the pendant 300 is not in radio range (e.g., no connection via main radio 308 or secondary radio 310), and/or the like. The pendant 300 can also define reporting for the lost pendant event (e.g., activate a tone over speaker 312, display lights on LED array 316, etc.). In additional examples, pendant 300 can communicate with other devices, such as a vital statistic monitoring device (e.g., a sphygmomanometer, pulse rate detector, internal thermometer, etc.) to detect and/or report events related thereto.

Referring to FIGS. 4 and 5, methodologies that can be utilized in accordance with various aspects described herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 4 illustrates an example methodology 400 for generating alerts for reported events in an emergency assistance system. At 402, a report of an event with related information can be received. As described, the event can be detected using an event detecting device that can report the event along with the related information. The related information can include audio recorded based on detecting the event, measurements from components of the event detecting device taken before, during, or after the event, and/or the like.

At 404, a severity of the event can be determined based at least in part on the related information. For example, the severity can be determined by analyzing the related information. In one example, where the related information relates to recorded audio, analyzing the audio can include evaluating a transcription of the audio in an attempt to locate certain words indicative of a level of severity, detecting patterns in the audio that may indicate a level of severity, evaluating audio attributes, such as intensity, volume, etc., as compared to one or more thresholds to determine a level of severity, and/or the like. Where the related information includes component measurements of the pendant, the measurements can be compared to one or more thresholds to determine a level of severity, as described.

At 406, one or more alerts are generated for responding to the event based at least in part on the severity. This can include determining an alert based on the indicated level of severity, such as dispatching emergency services for events over a threshold severity, alerting on-site personnel for events having at least another severity, and/or the like.

FIG. 5 illustrates an example methodology 500 for generating alerts for events based on a determined severity. At 502, a report of an event and related audio recording are received. The audio recording can relate to a time period following detection of the event at an event detecting device, such as a wearable pendant, wall-mounted device, etc. in an emergency assistance system. At 504, the audio is transcribed. This can include performing an automated transcription, receiving a transcription from a service, and/or the like. Words in the transcription can indicate a severity of the event as the user of the event detecting device, or surrounding users, may say something indicative of a level of assistance desired, such as “emergency,” “help” and/or the like.

At 506, it can be determined whether certain words are detected in a transcript of the audio. If so, a higher severity can be assigned to the event at 508. This can include assigning a severity based on the word or words detected in the transcript, the number of detected words, and/or the like. If certain words are not detected in the transcript, a lower severity can be assigned to the event at 510. At 512, one or more alerts can be generated based on the severity. As described, where the severity achieves a threshold, emergency services can be dispatched, where the severity achieves a different threshold, on-site personnel can be notified of the event, contact can be attempted on the device reporting the event, and/or the like.

To provide a context for the various aspects of the disclosed subject matter, FIGS. 6 and 7 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 6, an exemplary environment 600 for implementing various aspects disclosed herein includes a computer 612 (e.g., desktop, laptop, server, hand held, programmable consumer or industrial electronics . . . ). The computer 612 includes a processing unit 614, a system memory 616 and a system bus 618. The system bus 618 couples system components including, but not limited to, the system memory 616 to the processing unit 614. The processing unit 614 can be any of various available microprocessors. It is to be appreciated that dual microprocessors, multi-core and other multiprocessor architectures can be employed as the processing unit 614.

The system memory 616 includes volatile and nonvolatile memory. The basic input/output system (BIOS), containing the basic routines to transfer information between elements within the computer 612, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 612 also includes removable/non-removable, volatile/non-volatile computer storage media. FIG. 6 illustrates, for example, mass storage 624. Mass storage 624 includes, but is not limited to, devices like a magnetic or optical disk drive, floppy disk drive, flash memory or memory stick. In addition, mass storage 624 can include storage media separately or in combination with other storage media.

FIG. 6 provides software application(s) 628 that act as an intermediary between users and/or other computers and the basic computer resources described in suitable operating environment 600. Such software application(s) 628 include one or both of system and application software. System software can include an operating system, which can be stored on mass storage 624, that acts to control and allocate resources of the computer system 612. Application software takes advantage of the management of resources by system software through program modules and data stored on either or both of system memory 616 and mass storage 624.

The computer 612 also includes one or more interface components 626 that are communicatively coupled to the bus 618 and facilitate interaction with the computer 612. By way of example, the interface component 626 can be a port (e.g., serial, parallel, PCMCIA, USB, FireWire . . . ) or an interface card (e.g., sound, video, network . . . ) or the like. The interface component 626 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 612 to output device(s) via interface component 626. Output devices can include displays (e.g., cathode ray tube (CRT), liquid crystal display (LCD), light emitting diode (LCD), plasma . . . ), speakers, printers and other computers, among other things.

According to an example, computer 612 can perform functionality of various components described herein, such as severity determining component 106, alerting component 108, etc., as described. In this example, the processing unit(s) 614 can comprise or receive instructions related to determining severity of an event, generating or rendering alerts based on the severity, and/or other aspects described herein. It is to be appreciated that the system memory 616 can additionally or alternatively store such instructions and the processing unit(s) 614 can be utilized to process the instructions.

FIG. 7 is a schematic block diagram of a sample-computing environment 700 with which the subject innovation can interact. The environment 700 includes one or more client(s) 710. The client(s) 710 can be hardware and/or software (e.g., threads, processes, computing devices). The environment 700 also includes one or more server(s) 730. Thus, environment 700 can correspond to a two-tier client server model or a multi-tier model (e.g., client, middle tier server, data server), amongst other models. The server(s) 730 can also be hardware and/or software (e.g., threads, processes, computing devices). The servers 730 can house threads to perform transformations by employing the aspects of the subject innovation, for example. One possible communication between a client 710 and a server 730 may be in the form of a data packet transmitted between two or more computer processes.

The environment 700 includes a communication framework 750 that can be employed to facilitate communications between the client(s) 710 and the server(s) 730. Here, the client(s) 710 can correspond to program application components and the server(s) 730 can provide the functionality of the interface and optionally the storage system, as previously described. The client(s) 710 are operatively connected to one or more client data store(s) 760 that can be employed to store information local to the client(s) 710. Similarly, the server(s) 730 are operatively connected to one or more server data store(s) 740 that can be employed to store information local to the servers 730.

By way of example, one or more clients 710 can include event detecting devices, and server(s) 730 can include one or more components of the emergency assistance system (e.g., a severity determining component 106, an alert delivering component 108), which can communicate via communication framework 750. The client(s) 710 can report events and related information to the server(s) 730 over communication framework 750, and the server(s) 730 can, in one example, determine a severity of the events based on the related information, generate a rendering of an alert based on the severity, etc., and can transmit such back to client(s) 710 via communication framework 750. In this example, client(s) 710 can also include monitoring stations (e.g., at an on-site facility, at emergency medical services, etc.).

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise random access memory (RAM), read-only memory (ROM), electrically erasable programmable ROM (EEPROM), compact disc (CD)-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While one or more aspects have been described above, it should be understood that any and all equivalent realizations of the presented aspects are included within the scope and spirit thereof. The aspects depicted are presented by way of example only and are not intended as limitations upon the various aspects that can be implemented in view of the descriptions. Thus, it should be understood by those of ordinary skill in this art that the presented subject matter is not limited to these aspects since modifications can be made. Therefore, it is contemplated that any and all such embodiments are included in the presented subject matter as may fall within the scope and spirit thereof.

What is claimed is:

1. A system for generating alerts for events in an emergency assistance system, comprising:
an event data aggregating component configured to receive a report of an event and related information;
a severity determining component configured to determine a severity of the event based at least in part on the related information; and
an alerting component configured to generate one or more alerts based at least in part on the severity of the event.

2. The system of claim 1, wherein the related information comprises audio recorded by a network connected microphone or camera installed at the site of the event based on occurrence of the event.

3. The system of claim 1, wherein the related information comprises audio recorded by a device that reports the event based on occurrence of the event.

4. The system of claim 3, wherein the severity determining component comprises an audio processing component configured to determine one or more parameters related to the audio, and wherein the severity determining component determines the severity of the event based at least in part on the one or more parameters.

5. The system of claim 4, wherein the audio processing component is configured to evaluate a transcript of the audio to determine occurrence of one or more words, wherein the one or more parameters comprise occurrence information for the one or more words in the transcript.

6. The system of claim 4, wherein the audio processing component is configured to evaluate patterns in the audio, wherein the one or more parameters comprise one or more patterns matched in the audio.

7. The system of claim 4, wherein the audio processing component is configured to analyze one or more attributes of the audio, wherein the one or more parameters comprise the one or more attributes.

8. The system of claim 7, wherein the one or more attributes comprise a volume level or intensity of at least a portion of the audio.

9. The system of claim 3, wherein the event relates to an emergency button push on the device, and the audio is recorded by the device in response to the emergency button push event.

10. The system of claim 1, further comprising an event parameter measuring component configured to analyze one or more parameters in the related information to determine the severity of the event.

11. The system of claim 10, wherein the one or more parameters relate to measurements of one or more components of a device that reports the event taken before, during, or after the event.

12. The system of claim 11, wherein the event is a fall, the one or more parameters relate to acceleration measurements of an accelerometer of the device related to the fall, and the severity determining component determines the severity of the fall based at least in part on comparing the acceleration measurements to one or more thresholds.

13. The system of claim 11, wherein the one or more parameters correspond to a location, time of day, activity or inactivity, camera input, or a medical profile.

14. The system of claim 1, wherein the alerting component generates the one or more alerts to dispatch emergency services where the severity of the event achieves a threshold.

15. The system of claim 1, wherein the alerting component generates the one or more alerts to an on-site monitoring station where the severity of the event achieves a threshold.

16. A method for generating alerts for events in an emergency assistance system, comprising:
receiving a report of an event from an event detecting device along with related information;
determining a severity of the event based at least in part on the related information; and
generating one or more alerts for responding to the event based at least in part on the severity.

17. The method of claim 16, wherein the related information comprises audio recorded by a device that reports the event based on occurrence of the event, and wherein the determining the severity is based at least in part on one or more parameters observed of the audio.

18. The method of claim 17, wherein the one or more parameters comprise occurrence information for one or more words in a transcript of the audio.

19. The method of claim 17, wherein the one or more parameters comprise one or more patterns matched or attributes analyzed in the audio.

20. A pendant for reporting events in an emergency assistance system, comprising:
one or more components configured to measure environmental aspects related to the pendant;
an event parameter measuring component to determine a severity of one or more events detected based at least in part on measurements from the one or more components; and
a main radio to report the one or more vents and the severity to the emergency assistance system.
